(19) United States
(12) Patent Application Publication
(10) Pub. No.: US 2007/0007073 A1
(43) Pub. Date: Jan. 11, 2007

(54) Step and support for vehicle mechanics

(76) Inventor: Edward A. Keller, Johns Island, SC (US)

Correspondence Address: B. Craig Killough;Barnwell Whaley Patterson & Helms, LLC, P.O. Drawer H, Charleston, SC, 29402-0197, US

(21) Appl. No.: 11/444,840

(22) Filed: Jun. 1, 2006

Related U.S. Application Data
(60) Provisional application No. 60/693,221, filed on Jun. 23, 2005.

(51) Int. Cl. E06C 7/16

(52) U.S. Cl. 182/115

(57) ABSTRACT

A work surface is supported by a frame mounted to a front of a vehicle. The frame has a step that is mounted to the frame. The device is supported against the vehicle, and by hooks that are located near, or extend through, the lower frontal portion of the vehicle. A generally horizontal support surface that allows the mechanic to recline above the engine compartment is provided, and a step allows access to the support surface and/or the engine compartment.

### Applicant claims the benefit of Provisional Application Ser. No. 60/693,221 filed Jun. 23, 2005.

### BACKGROUND OF THE INVENTION

Engine compartments of trucks and other large vehicles are at a height that makes it impractical for the mechanic to work without having elevation assistance, which may be a floor supported step. This requirement is not limited to large trucks. Many pick-up trucks, sport utility vehicles and similar vehicles are of sufficient height that the access to the engine compartment requires a step or small ladder type device to provide a reasonable working height for the mechanic.

A step will elevate the mechanic to a proper work height, but the width of the body work, and the presence of core supports, radiator, fenders, and other articles and devices placed around the perimeter of the engine compartment inhibit access to the engine. The best physical position for the mechanic while working on the engine of a truck or other vehicle may be a prostrate position, that is, the mechanic may prefer to be lying down and facing the engine. There is a need for a portable device that provides a step for elevating the mechanic to the engine compartment, and after the mechanic is elevated, the mechanic is supported in a reclining position or a position where the mechanic is lying face down over the front of the vehicle, so that the mechanic can work on the engine or other parts, components and devices that are positioned under the hood or bonnet of the vehicle.

### SUMMARY OF THE INVENTION

The present invention is a step and generally horizontal support that is mounted to the vehicle. The device is supported by the structure of the vehicle, such as by positioning the device adjacent to the radiator core support of the vehicle, and by hooks that are positioned in tow eyes of the vehicle that are located near, or extend through, the lower frontal portion of the vehicle. A generally horizontal support surface that allows the mechanic to recline above the engine compartment is provided, and the step allows access to the support surface, from which the engine compartment of the vehicle is easily accessible.

### DESCRIPTION OF THE DRAWINGS

FIG. 1 is a perspective view of the device shown in position on a vehicle. The generally horizontal support member is not mounted.

FIG. 2 is a perspective view of the device shown in position on a vehicle. The generally horizontal support member is mounted to the upper portion of the frame.

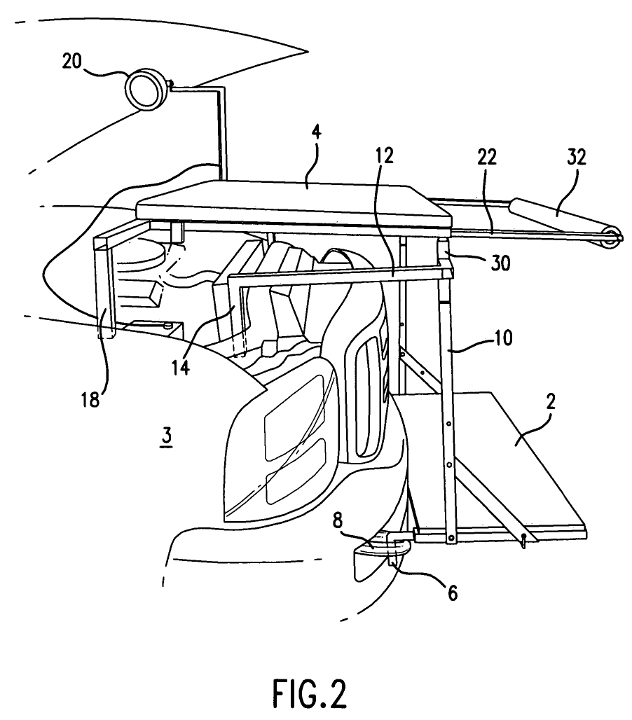

FIG. 3 is a perspective view of the device with the sub-frame and the generally horizontal support member exploded away from the frame of the device.

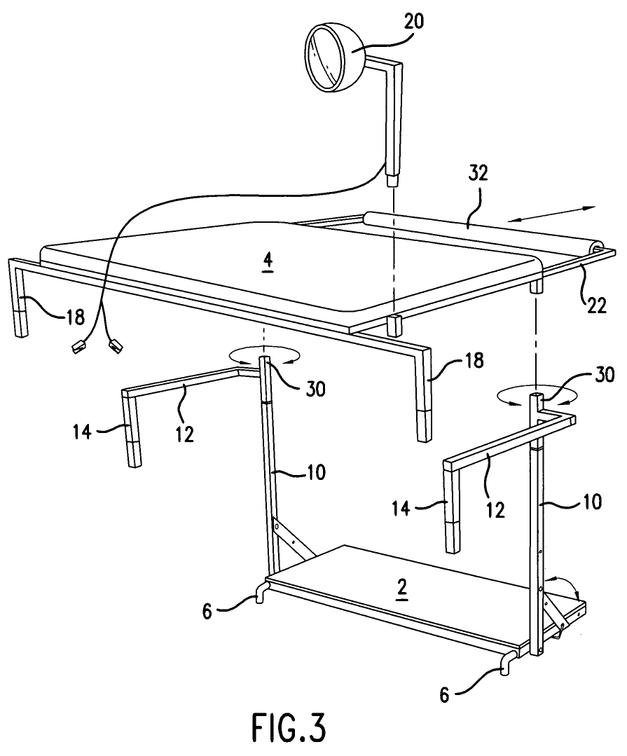

### DETAILED DESCRIPTION OF THE PREFERRED EMBODIMENT

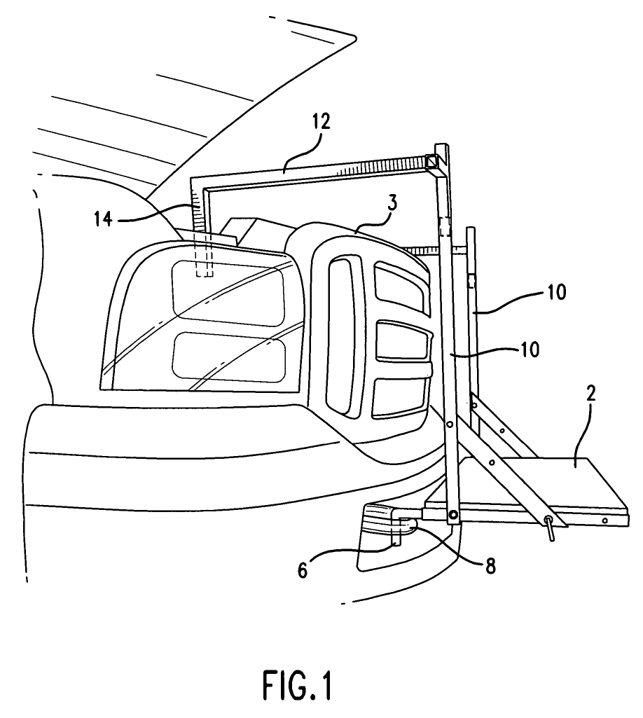

As shown in FIG. 1, the device of a preferred embodiment has a step 2, a support surface and a frame for mounting the step and the support surface to the front of the vehicle 3. The step may be a generally horizontal plane. Hooks 6 extend from one side of the step. Mounting hooks are inserted into receptacles, or eyes 8, that may extend through the front bumper of the vehicle. The eyes are mounted at the factory when most vehicles are constructed, and are used, for example, for pulling the vehicle along the assembly line during assembly. The eyes are fixed to the vehicle. In the present invention, the eyes are used for mounting the frame of the device near the step, by receiving the mounting hooks of the invention. The step is present on a lower portion of the device, and is connected to the remainder of the device by the frame.

The support surface 4 is mounted on an upper portion of the frame, and is present on an upper portion of the device. The support surface is positioned over the front of the vehicle, and is typically present above the radiator, radiator core support and grille. It is preferred that the support surface not materially cover any portion of the engine when the device is in position on the vehicle, so that the mechanic has full access to the engine from the support surface. The support surface should be of sufficient size for an adult to lie upon, and should be not less than 2 feet in width and not less than 3 feet in length.

In a preferred embodiment, the frame has at least two generally vertically extending support members 10 that extend from the step to at least two horizontal support members 12. Opposite the generally vertically extending support members 10 are vertical members 14 on each side that extend downwardly. On an opposite end of these vertical members may be shorter horizontal members that are inserted underneath a portion of the front of the vehicle, such as the unibody structure of the vehicle that is adjacent to the radiator, or the radiator core supports. However, as shown the frame is supported by the vehicle when the hooks 6 are present in the eyes 8, and the vertical members 14 are positioned against the vehicle, such as being positioned against the rear surface of the radiator core support of the vehicle. In the preferred embodiment, the frame is supported by the hooks and the vertical members, and no fasteners are used to hold the frame in position on the vehicle.

The generally horizontal support surface 4 may be supported by a sub-frame. The sub-frame may comprise support members 18, which may extend downwardly vertically from the frame and contact structures, such as the inner fender, within the engine compartment to provide additional support. An extension bar 22 may extend from the front of the frame. This bar may be telescopically mounted to the frame at generally the same horizontal level as the support surface. The bar may be used to support, for example, the legs of the mechanic while the mechanic is lying on the support surface. The void between the bar and the support surface allows the mechanic to stand on the step with the bar in place. The horizontal support surface and the extension bar may be padded for comfort, such as shown by pad 32. The sub-frame may engage the frame by a male-female slidable engagement, such as at engagement 30, so that the sub-frame may be easily removed, and the device may be used with the step as a platform for the mechanic to stand on.

In use, the vertical support members 14 are inserted against the unibody structure of the vehicle, such as the core support members on each side of the radiator of the vehicle. The mounting hooks that extend from the frame near the step are inserted into the eyes that are permanently mounted on the vehicle to support and position the lower portion of the device. The auxiliary supports 18 may be positioned appropriately in the engine to provide additional support, but are placed so as to not damage components that are present under the hood.

The mechanic steps upon the step. The device may be used without the support surface in place, and the device used by the mechanic while standing on the step.

With the sub-frame and the support surface optionally in position on the frame of the device, the mechanic may climb upon the support surface and recline on it. As the mechanic reclines on the support surface, his or her body is positioned as necessary to work on the engine or other components that are present under the engine. Typically the user's torso is supported by the support surface 4, with the user's legs supported by the bar 22. The mechanic will typically lie face downward, looking at the engine compartment, with his arms extended beyond the generally horizontal support surface and free to work on the engine or other adjacent engine components.

The device also provides a support for a light 20 for the mechanic. The light may be capable of operating on 12 volts or 24 volts DC, and is connected to the vehicle's electrical system. Alternatively, the light may be plugged into a building's electrical system and operated on alternating current as available.

In the preferred embodiment, the device may be easily disassembled and folded as shown in the illustrations. The device may be stored by folding and is sufficiently light weight that it may be carried from vehicle to vehicle and reassembled, which is easily within the capability of a mechanic. The horizontal support members 12 rotate toward each other and relative to the vertically extending support members 10, and the step pivots upwardly toward to lie against the vertically extending support members, so that the frame is relatively flat for storage. The sub-frame may be positioned with the generally horizontal support surface in a generally vertical position and against the folded frame, so that the entire device is space efficient for storage and movement. Removable casters may be provided for the device for movement of the device from vehicle to vehicle.

The device is preferred to be supported by the vehicle. The weigh of the mechanic is supported by the frame, and if used, the sub-frame. The frame transfers the force from the weight of the mechanic to the vehicle. In the preferred embodiment, the device is not supported by a support object that communicates directly with the floor, other than the vehicle, so that neither the weight of the device nor the weight of the mechanic is transferred by a part of the device to the floor.

What is claimed is:

1. A work surface for a vehicle mechanic, comprising:
a frame, said frame having a first hook and a second hook on a lower portion of said frame, wherein said first hook and said second hook are spaced apart, and said first hook removably engages a first tow eye that extends to a front of a vehicle and said second hook removably engages a second tow eye that extends to said front of said vehicle, and wherein said frame has a first support and a second support on an upper portion of said frame, wherein said first support and said second support removably engage a core support of said vehicle;
a step, wherein said step is positioned generally between said first hook and said second hook; and
a generally horizontal support surface, wherein said generally horizontal support surface is positioned above said core support of said vehicle.

2. A work surface for a vehicle mechanic as described in claim 1, wherein said first support has a generally vertical member that extends behind said core support of said vehicle and said second support has a generally vertical member that extends behind said core support of said vehicle.

3. A work surface for a vehicle mechanic as described in claim 1, wherein said first hook has a generally vertical member that engages an interior of said first tow eye of said vehicle and wherein said second hook has a generally vertical member that engages an interior of said second tow eye of said vehicle.

4. A work surface for a vehicle mechanic as described in claim 1, further comprising a sub-frame, wherein said sub-frame engages said frame above said core support of said vehicle, and generally horizontal support surface is mounted to said sub-frame.

5. A work surface for a vehicle mechanic as described in claim 1, wherein substantially all of a force produced by a weight of a mechanic on said generally horizontal support surface is transferred to said frame, and from said frame to said vehicle.

6. A work surface for a vehicle mechanic as described in claim 1, wherein, when said first hook and said second hook are not engaged in said first tow eye and said second tow eye, and said first support and said second support do not engage said radiator core support, said step is pivotable from a generally horizontal position to a generally vertical position, and an end of each of said first support and said second support are inwardly rotatable toward each other.

7. A work surface for a vehicle mechanic as described in claim 1, further comprising a sub-frame, wherein said sub-frame engages said frame above said core support of said vehicle, and generally horizontal support surface is mounted to said sub-frame, and wherein said sub-frame rests against a portion of an engine compartment of said vehicle.
